(19) United States
(12) Patent Application Publication
(10) Pub. No.: US 2013/0080308 A1
(43) Pub. Date: Mar. 28, 2013

(54) Dynamic Leaning Tools

(71) Applicants: Patricia A. Messina, Chicago, IL (US); Bharat Mittal, Schaumburg, IL (US); Andrew Gottemoller, Chicago, IL (US)

(72) Inventors: Patricia A. Messina, Chicago, IL (US); Bharat Mittal, Schaumburg, IL (US); Andrew Gottemoller, Chicago, IL (US)

(73) Assignee: TRADING TECHNOLOGIES INTERNATIONAL, INC., Chicago, IL (US)

(21) Appl. No.: 13/245,406

(22) Filed: Sep. 26, 2011

(51) Int. Cl. G06Q 40/00

(52) U.S. Cl. 705/37

(57) ABSTRACT

Certain embodiments provide an “increase on re-quote” tool. According to the techniques of this tool, when the quantity available in a lean leg increases after the quantity of a quoting order has previously been decreased, the quantity for the quoting order is not increased until the quoting order is to be re-quoted at another price level. Certain embodiments provide a “quote inside market only and reload” tool. According to the techniques of this tool, a quoting order only leans on the inside market and, when the leaned on quantity decreases, the quoting quantity is reduced as appropriate. The quoting quantity does not increase, even if the available quantity in a lean leg increases. Instead, when the quoting order is filled, the strategy order is reloaded by placing a new quoting order for the remaining desired quantity, again leaning on only the quantity available at the inside market.

### BACKGROUND

An electronic trading system generally includes a trading device in communication with an electronic exchange. The electronic exchange transmits market data to the trading device. Market data includes, for example, price data, market depth data, last traded quantity data, and/or any data related to a market for a tradable object. In some electronic trading systems, the trading device sends trade orders to the electronic exchange. In another example, a server device, on behalf of the trading device, sends the trade orders to the electronic exchange. Upon receiving a trade order, the electronic exchange enters the trade order into an exchange order book and attempts to match quantity of the trade order with quantity of one or more contra-side trade orders.

In addition to trading single items, a user may trade more than one item according to a trading strategy. One common trading strategy is a spread and trading according to a trading strategy may also be referred to as spread trading. Spread trading may attempt to capitalize on changes or movements in the relationships between the items in the trading strategy, for example.

### BRIEF DESCRIPTION OF THE DRAWINGS

Certain embodiments are disclosed with reference to the following drawings.

FIG. 1 illustrates a block diagram of an electronic trading system in which certain embodiments may be employed.

FIG. 2 illustrates a block diagram of an example computing device that may be used to implement the disclosed embodiments.

FIG. 3 illustrates a block diagram of a trading strategy which may be employed with certain embodiments of the present inventions.

FIG. 4 illustrates an example flow diagram of a method for dynamic leaning according to an embodiment of the increase on re-quote tool.

FIG. 5 illustrates a timing diagram of an example sequence of messages according to an embodiment of the increase on request tool.

FIG. 6 illustrates an example flow diagram of a method for dynamic leaning according to an embodiment of the increase on re-quote tool.

FIG. 7 illustrates an example flow diagram of a method for dynamic leaning according to an embodiment of the quote inside market only and reload tool.

FIG. 8 illustrates a timing diagram of an example sequence of messages according to an embodiment of the quote inside market only and reload tool.

FIG. 9 illustrates a block diagram of an example trading device in accordance with certain embodiments.

Certain embodiments will be better understood when read in conjunction with the provided drawings, which illustrate examples. It should be understood, however, that the embodiments are not limited to the arrangements and instrumentality shown in the attached drawings.

### DETAILED DESCRIPTION

### I. Brief Description

The disclosed embodiments relate to tools for dynamic leaning. In some embodiments, an “increase on re-quote” tool is provided. In some embodiments, a “quote inside market only and reload” tool is provided.

Although the following discloses embodiments including, among other components, software executed on hardware, it should be noted that the embodiments are merely illustrative and should not be considered as limiting. For example, it is contemplated that any or all of these hardware and software components may be embodied exclusively in hardware, exclusively in software, exclusively in firmware, or in any combination of hardware, software, and/or firmware. Accordingly, the disclosed embodiments may be implemented in other ways.

Certain embodiments provide a method including receiving by a computing device a definition for a trading strategy including a first tradable object and a second tradable object; receiving by the computing device a desired strategy price and a desired strategy quantity for a trading strategy order; sending by the computing device a command to place a quoting order for the first tradable object having an order quantity; detecting by the computing device a decrease in the lean quantity for the quoting order; sending by the computing device a command to decrease the order quantity of the quoting order based on the detected decrease in the lean quantity; detecting by the computing device an increase in quantity available to lean on in the second tradable object; determining by the computing device a first new price for the quoting order based on the desired strategy price, the desired strategy quantity, and market data for the second tradable object; refraining by the computing device from sending a command to increase the order quantity of the quoting order; detecting by the computing device a change in quantity available to lean on in the second tradable object; determining by the computing device a second new price for the quoting order based on the definition for the trading strategy, the desired strategy price, the desired strategy quantity, and market data for the second tradable object; and re-quoting by the computing device the quoting order at the second new price and at a new quantity. The quoting order leans on a lean quantity in the second tradable object. The lean quantity is based on the definition for the trading strategy, the desired strategy quantity, and market data for the second tradable object. The first new price is the same as the order price. The second new price is different than the order price. The new quantity is greater than the decreased order quantity.

Certain embodiments provide a method including sending by a computing device a command to place a quoting order for a first tradable object at a first price and a first quantity; sending by the computing device a command to decrease the order quantity of the quoting order based on a decrease in the lean quantity; determining by the computing device a new price for the quoting order; and re-quoting by the computing device the quoting order at the new price and a new quantity. The quoting order leans on a lean quantity in a second tradable object. The new price is based on a definition for a trading strategy, a desired strategy price, a desired strategy quantity, and market data for the second tradable object. The trading strategy includes the first tradable object and the second tradable object. The new price is different from the first price. The new quantity is greater than the decreased order quantity.

Certain embodiments provide a method including receiving by a computing device a definition for a trading strategy including a first tradable object and a second tradable object; receiving by the computing device a desired strategy price and a desired strategy quantity for a trading strategy order; sending by the computing device a command to place a first quoting order for the first tradable object having a first order quantity; detecting by the computing device a decrease in the first lean quantity for the first quoting order; sending by the computing device a command to decrease the first order quantity of the first quoting order based on the detected decrease in the first lean quantity; receiving by the computing device a fill confirmation; and sending by the computing device a command to place a second quoting order for the first tradable object having a second order quantity. The first quoting order leans on a first lean quantity in the second tradable object. The first lean quantity is based on the definition for the trading strategy, the desired strategy quantity, and market data for the second tradable object. The first lean quantity includes only quantity available at one of a best bid price and a best ask price for the second tradable object. The fill confirmation indicates that the decreased first order quantity of the first quoting order has been filled. The second quoting order leans on a second lean quantity in the second tradable object. The second lean quantity is based on the definition for the trading strategy, the desired strategy quantity, and market data for the second tradable object. The second lean quantity includes only quantity available at one of a best bid price and a best ask price for the second tradable object. The second order quantity is a remaining quantity based on the definition for the trading strategy, the desired strategy quantity, and the filled quantity for the first quoting order.

### II. Example Electronic Trading System

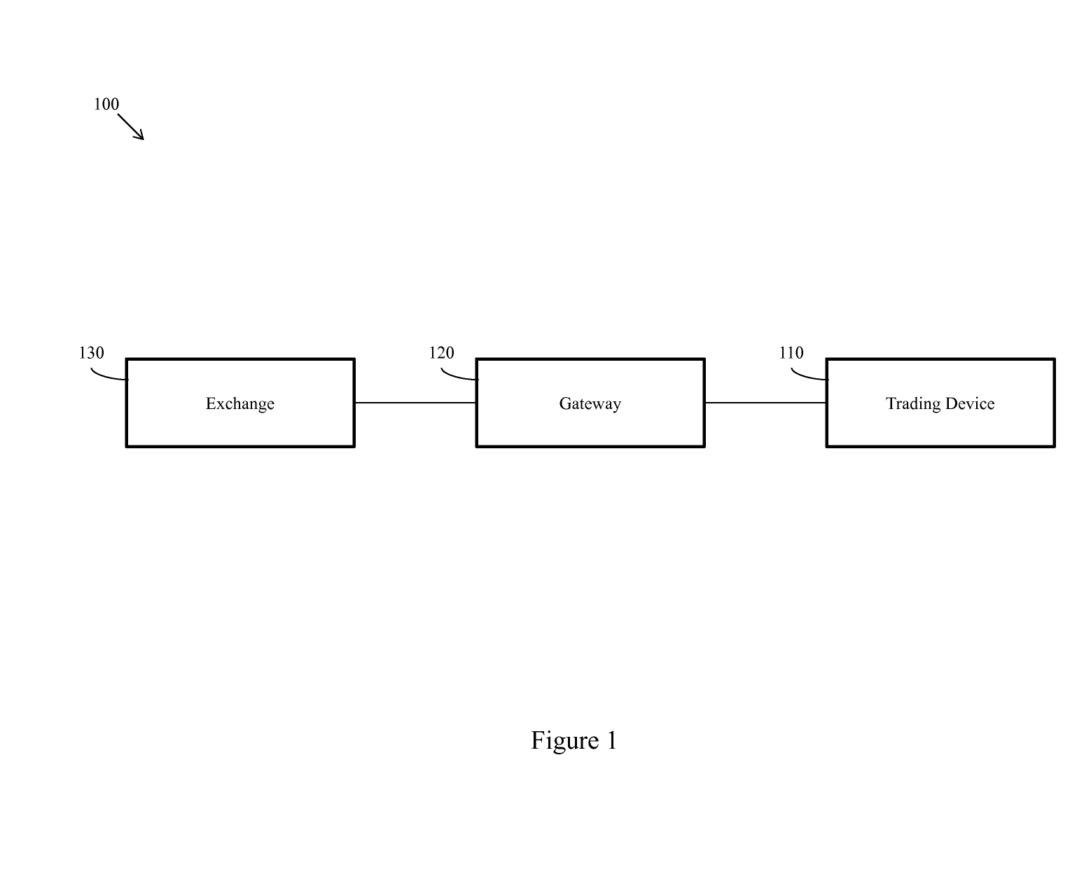

FIG. 1 illustrates a block diagram of an electronic trading system 100 in which certain embodiments may be employed. The system 100 includes a trading device 110, a gateway 120, and an electronic exchange 130. The trading device 110 is in communication with the gateway 120. The gateway 120 is in communication with the exchange 130.

As used herein, the phrase “in communication with” may include in direct communication and indirect communication through one or more intermediary components.

In operation, the trading device 110 may send orders to buy or sell tradable objects at the exchange 130. For example, a user may utilize the trading device 110 to send the orders. The orders are sent through the gateway 120 to the exchange 130. In addition, market data is sent from the exchange 130 through the gateway 120 to the trading device 110. The user may also utilize the trading device 110 to monitor this market data and/or base a decision to send an order for a tradable object on the market data.

A tradable object is anything which may be traded with a quantity and/or a price. For example, financial products, including stocks, options, bonds, futures, currency, warrants, funds derivatives, securities, commodities, swaps, interest rate products, index based products, traded events, goods, and collections and/or combinations of these, may be tradable objects. A tradable object may be “real” or “synthetic.” A real tradable object includes products that are listed and/or administered by an exchange. A synthetic tradable object includes products that are defined by the user. For example, a synthetic tradable object may include a combination of real (or other synthetic) products such as a synthetic spread created by a user utilizing a trading device 110. There may be a real tradable object that corresponds and/or is similar to a synthetic trading object.

The trading device 110 may include one or more electronic computing platforms such as a hand-held device, laptop, desktop computer, workstation with a single or multi-core processor, server with multiple processors, and/or cluster of computers, for example. For example, while logically represented as a single device, trading device 110 may include a trading terminal in communication with a server, where collectively the trading terminal and the server are the trading device 110. The trading terminal may provide a trading screen to a user and may communicate commands to the server for further processing of the user's inputs through the trading screen, such as placing orders.

The trading device 110 is generally owned, operated, controlled, programmed by, configured by, or otherwise used by a user. As used herein, the phrase “user” may include, but is not limited to, a human (for example, a trader) or an electronic trading device (for example, an algorithmic trading system). One or more users may be involved in the ownership, operation, control, programming, configuration, or other use, for example.

The trading device 110 may include one or more trading applications. The trading application(s) may, for example, process market data by arranging and displaying the market data in trading and charting windows. The market data may be received from exchange 130, for example. As another example, the market data may be received from a simulation environment that provides historical data and/or simulates an exchange but does not effectuate real-world trades. This processing may be based on user preferences, for example. The trading application(s) may include an automated trading tool such as an automated spread trading tool, for example. The one or more trading applications may be distributed across one or more of the computing devices of the trading device 110. For example, certain components of a trading application may be executed on a trading workstation and other components of the trading application may be executed on a server in communication with the workstation.

The trading device 110 may include an electronic trading workstation, a portable trading device, an algorithmic trading system such as a “black box” or “grey box” system, an embedded trading system, and/or an automated trading tool, for example. For example, the trading device 110 may be a computing system running a copy of X_TRADER®, an electronic trading platform provided by Trading Technologies International, Inc. of Chicago, Ill. As another example, the trading device 110 may be a computing device running an automated trading tool such as Autospreader® and/or Autotrader™, also provided by Trading Technologies International, Inc.

As another example, the trading device 110 may include a trading application which algorithmically processes market data and includes a user interface for manual placement of orders based on the algorithmic processing or to manipulate orders that were placed automatically. An algorithmic trading application is a trading application which includes an automatically processed algorithm to perform certain actions. That is, the trading application includes an automated series of instructions to perform defined action(s). The actions may include processing market data in a particular way, placing an order, modifying an existing order, deleting an order, refraining from placing an order, selecting which tradable object(s) to act on, determining a price to place or modify an order at, determining a quantity to place an order at or modify an order to be, determining whether an order should be to buy or sell, and delaying action for a period of time, for example.

As used herein, an algorithm (also referred to as a trading algorithm) is specified by a definition which includes logic expressions and parameters that describe the algorithm to be used in trading. Logic expressions specify the relationship between parameters and may generate more parameters. Parameters may include, for example, inputs into the logic expressions of the algorithm. The definition of an algorithm may be, at least in part, specified by the algorithmic trading application. For example, an algorithmic trading application may allow a user to only specify parameters to be used by pre-defined logic expressions. As another example, an algorithmic trading application may allow a user to specify some or all of the logic expressions and some or all of the parameters. A trading algorithm where the logic expressions are specified by a user is a user-defined trading algorithm.

Trading applications may be stored in a computer readable medium of the trading device 110. In certain embodiments, one or more components of a trading application may be stored on a trading workstation and other components of the trading application may be stored on a server in communication with the workstation. In certain embodiments, one or more components of a trading application may be loaded into the computer readable medium of the trading device 110 from another computer readable medium. For example, the trading application (or updates to the trading application) may be stored by a manufacturer, developer, or publisher on one or more CDs or DVDs, which are then provided to someone responsible for loading the application onto the trading device 110 or to a server from which the trading device 110 retrieves the trading application. As another example, the trading device 110 may receive the trading application (or updates to the trading application) from a server, for example, via the Internet or an internal network. The trading device 110 may receive the trading application or updates when requested by the trading device 110 (“pull distribution”) and/or un-requested by the trading device 110 (“push distribution”).

The trading device 110 is adapted to send orders for a tradable object. The orders may be sent in one or more messages or data packets or through a shared memory system, for example. The trading device 110 may also be adapted to cancel orders, change orders, and/or query an exchange, for example. As another example, the trading device 110 may be adapted to send orders to a simulated exchange in a simulation environment that does not effectuate real-world trades.

The orders sent by the trading device 110 may be sent at the request of a user or automatically, for example. For example, a trader may utilize an electronic trading workstation to place an order for a particular tradable object, manually providing one or more parameters for the order, such as an order price and/or quantity. As another example, an automated trading tool may calculate one or more parameters for an order and automatically send the order. In some instances, an automated trading tool may prepare the order to be sent but not actually send it without confirmation from the user.

In certain embodiments, the trading device 110 includes a user interface. The user interface may include one or more display devices for presenting a text-based and/or graphical interface of a trading application to a user, for example. For example, the display devices may include computer monitors, hand-held device displays, projectors, and/or televisions. The user interface may be used to specify or review parameters for an order using a trading application. The user interface may include one or more input devices for receiving input, for example. For example, the input devices may include a keyboard, trackball, two or three-button mouse, and/or touch screen. The user interface may include other devices for interacting with a user. For example, information may be audibly provided to a user through a speaker and/or received through a microphone.

In certain embodiments, a trading application includes one or more trading screens to enable a user to interact with one or more markets. Trading screens may enable users to obtain and view market information, set order entry parameters, enter and cancel orders, and/or monitor positions while implementing various trading strategies, for example. For example, a trading application may receive information (such as bid prices, bid quantities, ask prices, ask quantities, prices and quantities for past sales, and/or other market related information) from exchange 130, some or all of which, in turn, may be displayed with a user interface of trading device 110. Based on the received information, the trading screen may display a range of price levels and corresponding bid and ask quantities for the price levels in regard to tradable objects. In order to provide the user with pertinent trading information, the trading screen may display a range of prices (and the corresponding bid and ask quantities) around the inside market. The information may be continuously or regularly provided to the trading application, which allows the trading application to update the trading screen with current market information. A user may use the trading screen to place buy and sell orders for tradable objects or to otherwise trade the tradable objects based on the displayed information, for example.

Trading screens may display one or more trading tools. Trading tools are electronic tools that allow, assist with, and/or facilitate electronic trading. Exemplary trading tools include, but are not be limited to, charts, trading ladders, order entry tools, automated trading tools, automated spreading tools, risk management tools, order parameter tools, order entry systems, market grids, fill windows, and market order windows, combinations thereof, other electronic tools used for trading, preparing to trade, managing trades, or analyzing the market.

In certain embodiments, the orders from the trading device 110 are sent to the exchange 130 through the gateway 120. The trading device 110 may communicate with the gateway 120 using a local area network, a wide area network, a wireless network, a virtual private network, a T1 line, a T3 line, an integrated services digital network (“ISDN”) line, a point-of-presence, the Internet, and/or a shared memory system, for example.

The gateway 120 is adapted to communicate with the trading device 110 and the exchange 130. The gateway 120 facilitates communication between the trading device 110 and the exchange 130. For example, the gateway 120 may receive orders from the trading device 110 and transmit the orders to the exchange 130. As another example, the gateway 120 may receive market data from the exchange 130 and transmit the market data to the trading device 110.

In certain embodiments, the gateway 120 performs processing on data communicated between the trading device 110 and the exchange 130. For example, the gateway 120 may process an order received from the trading device 110 into a data format understood by the exchange 130. Similarly, the gateway 120 may transform market data in an exchange-specific format received from the exchange 130 into a format understood by the trading device 110. The processing of the gateway 120 may also include tracking orders from the trading device 110 and updating the status of the order based on fill confirmations received from the exchange 130, for example. As another example, the gateway 120 may coalesce market data from the exchange 130 and provide it to the trading device 110.

In certain embodiments, the gateway 120 provides services other than processing data communicated between the trading device 110 and the exchange 130. For example, the gateway 120 may provide risk processing.

The gateway 120 may include one or more electronic computing platforms such as a hand-held device, laptop, desktop computer, workstation with a single or multi-core processor, server with multiple processors, and/or cluster of computers, for example.

The gateway 120 may include one or more gateway applications. The gateway application(s) may, for example, handle order processing and market data processing. This processing may be based on user preferences, for example.

In certain embodiments, the gateway 120 communicates with the exchange 130 using a local area network, a wide area network, a virtual private network, a T1 line, a T3 line, an ISDN line, a point-of-presence, the Internet, and/or a shared memory system, for example.

In general, the exchange 130 may be owned, operated, controlled, or used by an exchange entity. Example exchange entities include the CME Group, the London International Financial Futures and Options Exchange (“LIFFE”), the IntercontinentalExchange (“ICE”), and Eurex. The exchange 130 may include an electronic matching system, such as a computer, server, or other computing device, that is adapted to allow tradable objects, for example, offered for trading by the exchange, to be bought and sold. The electronic matching system may include a matching engine, for example. The exchange 130 may include separate entities, some which list and/or administer tradable objects and others which receive and match orders, for example. The exchange 130 may include an electronic communication network (“ECN”), for example.

The exchange 130 is adapted to match orders to buy and sell tradable objects. The tradable objects may be listed for trading by the exchange 130. The orders may include orders received from the trading device 110, for example. Orders may be received from the trading device 110 through the gateway 120, for example. In addition, the orders may be received from other devices in communication with the exchange 130. That is, typically the exchange 130 will be in communication with a variety of other trading devices (which may be similar to trading device 110) that also provide orders to be matched.

The exchange 130 is adapted to provide market data. The market data may be provided in one or more messages or data packets or through a shared memory system, for example. The market data may be provided to the trading device 110, for example. The market data may be provided to the trading device 110 through the gateway 120, for example. The market data may include data that represents the inside market, for example. The inside market is the lowest sell price (also referred to as the “best ask”) and the highest buy price (also referred to as the “best bid”) at a particular point in time (since the inside market may vary over time). The market data may also include market depth. Market depth refers to the quantities available at the inside market and may also refer to quantities available at other prices away from the inside market. Thus, the inside market may be considered the first level of market depth. One tick away from the inside market may be considered the second level of market depth, for example. In certain embodiments, market depth is provided for all price levels. In certain embodiments, market depth is provided for less than all price levels. For example, market depth may be provided only for the first five price levels on both sides of the inside market. As another example, market depth may be provided for the first ten price levels at which quantity is available in the market. The market data may also include information such as the last traded price (LTP), the last traded quantity (LTQ), and order fill information.

In certain embodiments, the system 100 includes more than one trading device 110. For example, multiple trading devices similar to the trading device 110, discussed above, may be in communication with the gateway 120 to send orders to the exchange 130.

In certain embodiments, the system 100 includes more than one gateway 120. For example, multiple gateways similar to the gateway 120, discussed above, may be in communication with the trading device 110 and the exchange 130. Such an arrangement may be used to provide redundancy should one gateway 120 fail, for example.

In certain embodiments, the system 100 includes more than one exchange 130. For example, the gateway 120 may be in communication with multiple exchanges similar to the exchange 130, discussed above. Such an arrangement may allow the trading device 110 to trade at more than one exchange through the gateway 120, for example.

In certain embodiments, the system 100 includes more than one exchange 130 and more than one gateway 120. For example, multiple gateways similar to the gateway 120, discussed above, may be in communication with multiple exchanges similar to the exchange 130, discussed above. Each gateway may be in communication with one or more different exchanges, for example. Such an arrangement may allow one or more trading devices 110 to trade at more than one exchange (and/or provide redundant connections to multiple exchanges), for example.

In certain embodiments, the trading device 110 includes one or more computing devices or processing components. In other words, the functionality of the trading device 110 may be performed by more than one computing device. For example, one computing device may generate orders to be sent to the exchange 130 while another computing device may provide a graphical user interface to a user. In certain embodiments, the gateway 120 includes one or more computing devices or processing components. In other words, the functionality of the gateway 120 may be performed by more than one computing device. In certain embodiments, the exchange 130 includes one or more computing devices or processing components. In other words, the functionality of the exchange 130 may be performed by more than one computing device.

In certain embodiments, the gateway 120 is part of the trading device 110. For example, the components of the gateway 120 may be part of the same computing platform as the trading device 110. As another example, the functionality of the gateway 120 may be performed by components of the trading device 110. In certain embodiments, the gateway 120 is not present. Such an arrangement may occur when the trading device 110 does not need to utilize the gateway 120 to communicate with the exchange 130, for example. For example, if the trading device 110 has been adapted to communicate directly with the exchange 130.

In certain embodiments, the gateway 120 is physically located at the same site as the trading device 110. In certain embodiments, the gateway 120 is physically located at the same site as the exchange 130. In certain embodiments, the trading device 110 is physically located at the same site as the exchange 130. In certain embodiments, the gateway 120 is physically located at a site separate from both the trading device 110 and the exchange 130.

In certain embodiments, the system 100 may include other devices that are specific to the communications architecture such as middleware, firewalls, hubs, switches, routers, exchange-specific communication equipment, modems, security managers, and/or encryption/decryption devices.

### III. Example Computing Device

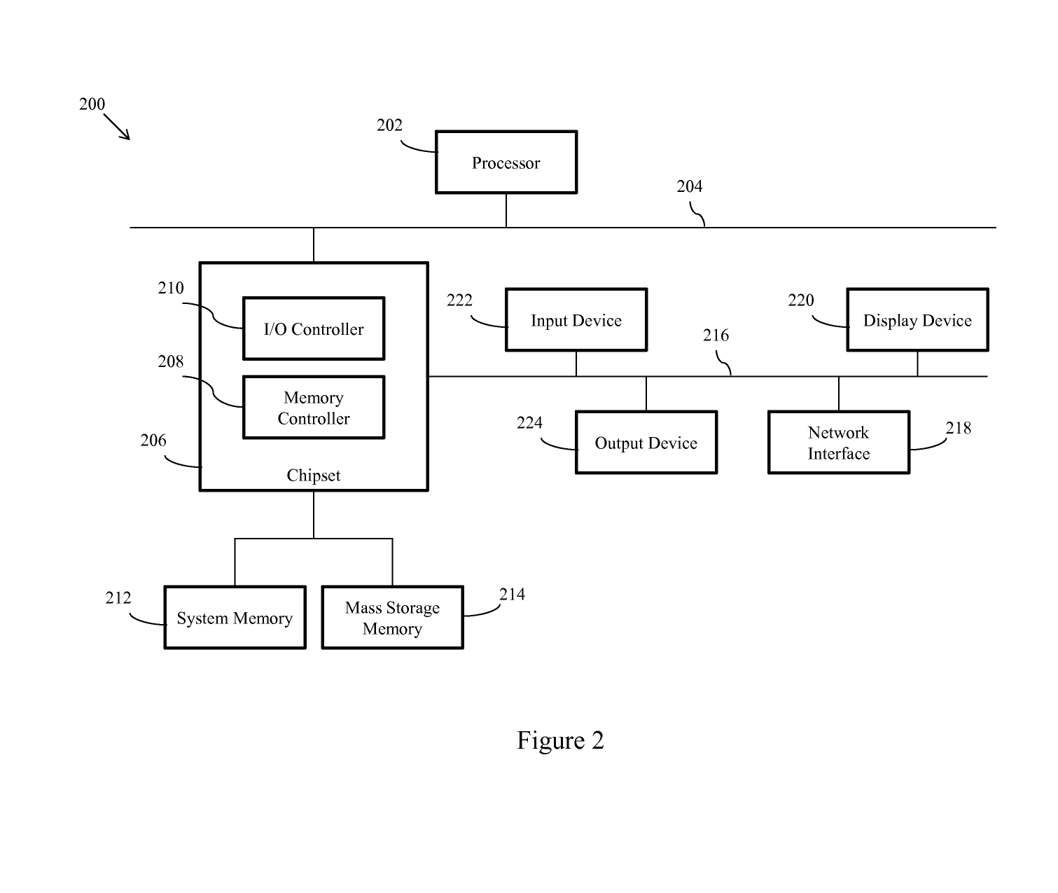

FIG. 2 illustrates a block diagram of an example computing device 200 that may be used to implement the disclosed embodiments. The trading device 110 of FIG. 1 may include one or more computing devices 200, for example. The gateway 120 of FIG. 1 may include one or more computing devices 200, for example. The exchange 130 of FIG. 1 may include one or more computing devices 200, for example.

The computing device 200 includes a processor 202, an interconnection bus 204, a chipset 206, a memory controller 208, an input/out (I/O) controller 210, a system memory 212, a mass storage memory 214, an I/O bus 216, a network interface 218, a display 220, an input device 222, and an output device 224. The computing device 200 may include additional, different, or fewer components. For example, multiple buses, multiple processors, multiple memory devices, multiple network interfaces, multiple display devices, multiple input devices, multiple output devices, or any combination thereof, may be provided. As another example, the computing device 200 may not include an output device 224 separate from the display device 220. As another example, the computing device 200 may not include a display device 220. As another example, the computing device 200 may not include an input device 222. Instead, for example, the computing device 200 may be controlled by an external or remote input device via the network interface 218.

The computing device 200 includes a processor 202 that is coupled to an interconnection bus 204. The interconnection bus 204 may include a communication bus, channel, network, circuit, switch, fabric, or other mechanism for communicating data between components in the computing device 200. The interconnection bus 204 may be communicatively coupled with and transfer data between any of the components of the computing device 200. For example, during an installation process of a trading application, one or more computer-readable instructions that are to be executed by the processor 202 may be transferred from the input device 222 and/or the network interface 218 to the system memory 212 and/or the mass storage memory 214. When the computing device 200 is running or preparing to run the trading application stored in the system memory 212 and/or the mass storage memory 214, the processor 202 may retrieve the instructions from the system memory 212 and/or the mass storage memory 214 via the interconnection bus 204.

The processor 202 may be a processor, processing unit, or microprocessor, for example. The processor 202 may include one or more general processors, digital signal processors, application specific integrated circuits, field programmable gate arrays, analog circuits, digital circuits, programmed processors, and/or combinations thereof, for example. The processor 202 may be a single device or a combination of devices, such as one or more devices associated with a network or distributed processing. Any processing strategy may be used, such as multi-processing, multi-tasking, parallel processing, and/or remote processing. Processing may be local or remote and may be moved from one processor to another processor. The computing device 200 may be a multi-processor system and, thus, may include one or more additional processors that are communicatively coupled to the interconnection bus 204.

The processor 202 may be operable to execute logic encoded in one or more tangible media, such as the system memory 212, the mass storage memory 214, and/or via the network interface 218. As used herein, logic encoded in one or more tangible media includes instructions that are executable by the processor 202 or a different processor. The logic may be stored as part of software, hardware, integrated circuits, firmware, and/or micro-code, for example. The logic may be received from an external communication device via a communication network, for example, connected to the Internet. The processor 202 may execute the logic to perform the functions, acts, or tasks illustrated in the figures or described herein.

The processor 202 of FIG. 2 is coupled to the chipset 206, which includes the memory controller 208 and the I/O controller 210. A chipset typically provides I/O and memory management functions as well as a plurality of general purpose and/or special purpose registers and timers that are accessible or used by one or more processors coupled to the chipset 206. The memory controller 208 performs functions that enable the processor 202 (or processors if there are multiple processors) to access the system memory 212 and the mass storage memory 214.

The system memory 212 and the mass storage memory 214 may be one or more tangible media, such as computer readable storage media, for example. The system memory 212 may include various types of volatile and non-volatile storage media, including, for example, random access memory (RAM), read-only memory (ROM), programmable read-only memory (PROM), electrically programmable read-only memory (EPROM), electrically erasable read-only memory (EEPROM), flash memory, any other tangible data storage device, any combination thereof. The mass storage memory 214 may include various types of mass storage devices including, for example, a hard disk drive, optical media, magnetic tape, any other tangible data storage device, or any combination thereof. In certain embodiments, the system memory 212 and the mass storage memory 214 are non-transitory.

The system memory 212 and the mass storage memory 214 may be a single memory module, for example. The system memory 212 and the mass storage memory 214 may be adjacent to, part of, programmed with, networked with, and/or remote from processor 202, such that data stored in the system memory 212 and the mass storage memory 214 may be retrieved and processed by the processor 202, for example. The system memory 212 and the mass storage memory 214 may store instructions that are executable by the processor 202. The instructions may be executed to perform one or more of the acts or functions described herein or shown in the figures.

The I/O controller 210 performs functions that enable the processor 202 to communicate with the network interface 218, the display 220, the input device 222, and the output device 224 through an I/O bus 216. While the memory controller 208 and the I/O controller 210 are depicted in FIG. 2 as separate blocks within the chipset 206, the functions performed by these blocks may be integrated within a single semiconductor circuit or may be implemented using two or more separate integrated circuits. One or more of the components of the computing device 200 may be implemented as a system on a chip (for example, a system on a chip in an IPHONE™).

The network interface 218 may be a one-way or two-way communication coupling. Accordingly, the network interface 218 may communicatively connect one, two, or more communication networks or devices. For example, the interconnection bus 204 may be coupled with a gateway similar to gateway 120 of FIG. 1 discussed above via the network interface 218, such that one, some, or all of the components of the computing device 200 are accessible or may communicate with the gateway. As another example, the network interface 218 may couple the interconnection bus 204 with other communication networks. The network interface 218 may be, for example, an integrated services digital network (ISDN) card or a modem to provide a data communication connection. As another example, network interface 218 may be a local area network (LAN) card to provide a data communication connection to a compatible LAN, for example, connected to the Internet. Wireless links may also be implemented. The network interface 218 may send and receive electrical, electromagnetic, or optical signals that carry analog or digital data streams representing various type of information, for example.

The display device 220 may include a visual output device, cathode ray tube (CRT) display, electronic display, electronic paper, flat panel display, light-emitting diode (LED) display, electroluminescent display (ELD), plasma display panel (PDP), liquid crystal display (LCD), thin-film transistor display (TFT), organic light-emitting diode display (OLED), surface-conduction electron-emitter display (SED), laser television, carbon nanotubes, nanocrystal display, head-mounted display, projector, three-dimensional display, and/or transparent display device, for example.

The display device 220 is adapted to display a trading screen. The trading screen may be similar to the trading screens discussed above, for example. The trading screen may be interactive. An interactive trading screen may allow, for example, one or more trading actions to be performed using the trading screen. For example, an interactive trading screen may allow one or more order entry parameters to be set and/or sent using one or more order entry actions. The display device 220 and/or the input device 222 may be used to interact with the trading screen, for example.

The input device 222 may include a keyboard, mouse, microphone, touch-screen, trackball, keypad, joystick, and/or other device for providing input, for example. The input device 222 may be used, for example, to provide command selections to processor 202. For example, the input device 222 may be a mouse that is used to control a cursor displayed on a trading screen. The mouse may include one or more buttons for selection and control, for example.

The output device 224 may include a keyboard, mouse, speakers, touch-screen, trackball, keypad, haptic device or system, joystick, and/or other device for providing output, for example. For example, the output device 224 may be used to output one or more signals, such as a haptic signal or an audio signal, to a user. While the input device 222 and output device 224 are depicted in FIG. 2 as separate blocks, the functions performed by these blocks may be integrated into a single I/O device.

### IV. Strategy Trading

In addition to buying and/or selling a single tradable object, a user may trade more than one tradable object according to a trading strategy. One common trading strategy is a spread and trading according to a trading strategy may also be referred to as spread trading. Spread trading may attempt to capitalize on changes or movements in the relationships between the tradable object in the trading strategy, for example.

An automated trading tool may be utilized to trade according to a trading strategy, for example. For example, the automated trading tool may Autospreader™ provided by Trading Technologies International, Inc. of Chicago, Ill.

A trading strategy defines a relationship between two or more tradable objects to be traded. Each tradable object being traded as part of a trading strategy may be referred to as a leg or outright market of the trading strategy.

When the trading strategy is to be bought, the definition for the trading strategy specifies which tradable object corresponding to each leg should be bought or sold. Similarly, when the trading strategy is to be sold, the definition specifies which tradable objects corresponding to each leg should be bought or sold. For example, a trading strategy may be defined such that buying the trading strategy involves buying one unit of a first tradable object for leg A and selling one unit of a second tradable object for leg B. Selling the trading strategy typically involves performing the opposite actions for each leg.

In addition, the definition for the trading strategy may specify a spread ratio associated with each leg of the trading strategy. The spread ratio may also be referred to as an order size for the leg. The spread ratio indicates the quantity of each leg in relation to the other legs. For example, a trading strategy may be defined such that buying the trading strategy involves buying 2 units of a first tradable object for leg A and selling 3 units of a second tradable object for leg B. The sign of the spread ratio may be used to indicate whether the leg is to be bought (the spread ratio is positive) or sold (the spread ratio is negative) when buying the trading strategy. In the example above, the spread ratio associated with leg A would be “2” and the spread ratio associated with leg B would be “−3.”

In some instances, the spread ratio may be implied or implicit. For example, the spread ratio for a leg of a trading strategy may not be explicitly specified, but rather implied or defaulted to be “1” or “−1.”

In addition, the spread ratio for each leg may be collectively referred to as the spread ratio or strategy ratio for the trading strategy. For example, if leg A has a spread ratio of “2” and leg B has a spread ratio of “−3”, the spread ratio (or strategy ratio) for the trading strategy may be expressed as “2:−3” or as “2:3” if the sign for leg B is implicit or specified elsewhere in a trading strategy definition.

Additionally, the definition for the trading strategy may specify a multiplier associated with each leg of the trading strategy. The multiplier is used to adjust the price of the particular leg for determining the price of the spread. The multiplier for each leg may be the same as the spread ratio. For example, in the example above, the multiplier associated with leg A may be “2” and the multiplier associated with leg B may be “−3,” both of which match the corresponding spread ratio for each leg. Alternatively, the multiplier associated with one or more legs may be different than the corresponding spread ratios for those legs. For example, the values for the multipliers may be selected to convert the prices for the legs into a common currency.

The following discussion assumes that the spread ratio and multipliers for each leg are the same, unless otherwise indicated. In addition, the following discussion assumes that the signs for the spread ratio and the multipliers for a particular leg are the same and, if not, the sign for the multiplier is used to determine which side of the trading strategy a particular leg is on.

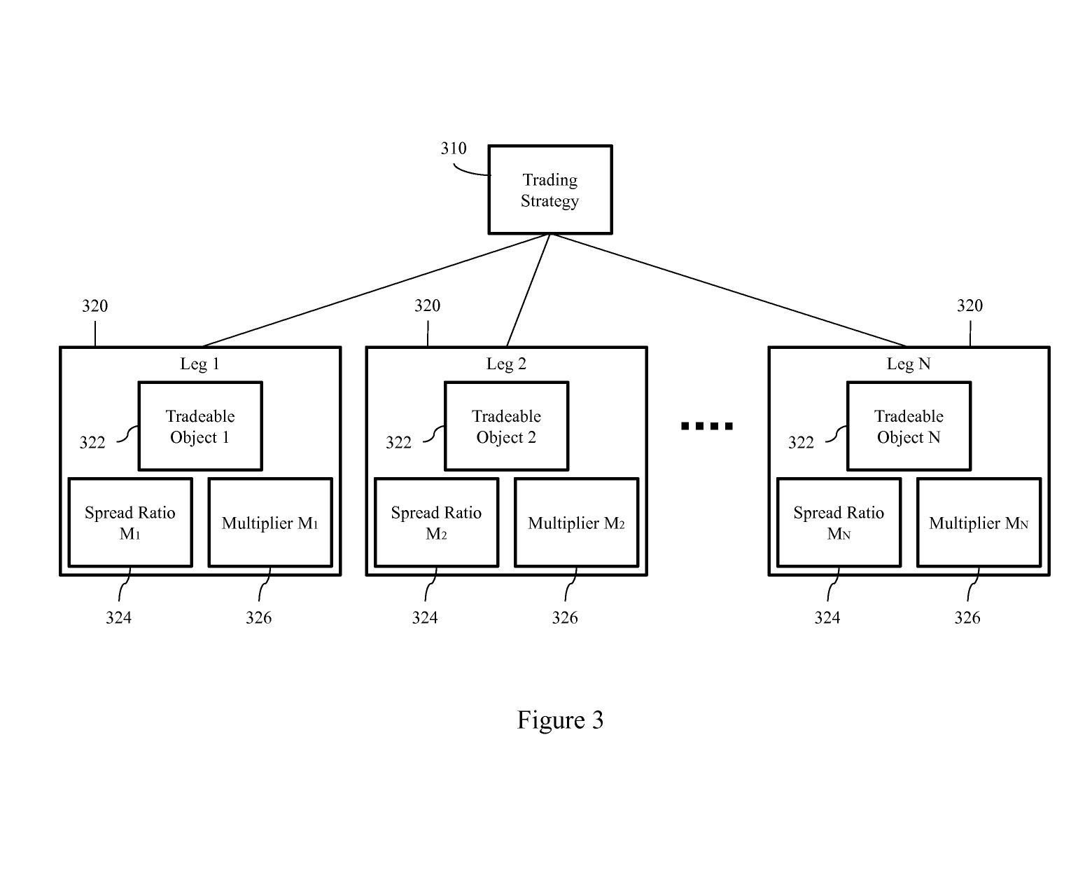

FIG. 3 illustrates a block diagram of a trading strategy 310 which may be employed with certain embodiments of the present inventions. The trading strategy 310 includes “N” legs 320. The trading strategy 310 defines the relationship between the tradable objects 322 for each of the legs 320 using the spread ratios 324 and multipliers 326 associated with each of the legs 320.

Once defined, the tradable objects 322 in the trading strategy 310 may then be traded together according to the defined relationship. For example, assume that the trading strategy 310 is a spread with two legs 320. Leg 1 is for tradable object A and Leg 2 is for tradable object B. In addition, assume that the spread ratios 324 and multipliers 326 associated with Legs 1 and 2 are “1” and “−1,” respectively. That is, the spread 310 is defined such that when the spread 310 is bought, 1 unit of tradable object A is bought (positive spread ratio, same direction as the spread) and 1 unit of tradable object B is sold (negative spread ratio, opposite direction of the spread). As mentioned above, typically in spread trading the opposite of the definition applies. That is, when the definition for the spread 310 is such that when the spread 310 is sold, 1 unit of tradable object A is sold (positive spread ratio, same direction as the spread) and 1 unit of tradable object B is bought (negative spread ratio, opposite direction of the spread).

The price for the trading strategy 310 is determined based on the definition. In particular, the price for the trading strategy 310 is typically the sum of price of the tradable object 322 multiplied by the multiplier 326 for each of the legs 320 of the trading strategy 310. The price for a trading strategy may be affected by price tick rounding and/or pay-up ticks. However, both of these implementation details are beyond the scope of this discussion and are well-known in the art.

Recall that, as discussed above, a real spread may be listed at an exchange, such as exchange 130 and/or 230, as a tradable product. In contrast, a synthetic spread may not be listed as a product at an exchange, but rather the various legs of the spread are tradable at one or more exchanges. For the purposes of the following discussion, the trading strategy 310 is discussed as a synthetic trading strategy. However, similar techniques to those discussed below may also be applied by an exchange when a real trading strategy is being traded.

Continuing the example from above, if it is expected or believed that tradable object A typically has a price 10 greater than tradable object B, then it may be advantageous to buy the spread whenever the difference in price between tradable objects A and B is less than 10 and sell the spread whenever the difference is greater than 10. As an example, assume that tradable object A is at a price of 45 and tradable object B is at a price of 40. The current spread price may then be determined to be (1)(45)+(−1)(40)=5, which is less than the typical spread of 10. Thus, a user may buy 1 unit of the spread, which results in buying 1 unit of tradable object A at a price of 45 and selling 1 unit of tradable object B at 40. At some later time, the typical price difference may be restored and the price of tradable object A is 42 and the price of tradable object B is 32. At this point, the price of the spread is now 10. If the user sells 1 unit of the spread to close out his position (that is, sells 1 unit of tradable object A and buys 1 unit of tradable object B), he has made a profit on the total transaction. In particular, while the user bought tradable object A at a price of 45 and sold at 42, losing 3, the user sold tradable object B at a price of 40 and bought at 32, for a profit of 8. Thus, the user made 5 on the buying and selling of the spread.

The above example assumes that there is sufficient liquidity and stability that the tradable objects can be bought and sold at the market price at approximately the desired times. This allows the desired price for the spread 310 to be achieved. However, more generally, a desired price at which to buy or sell a particular trading strategy is determined. Then, an automated trading tool, for example, attempts to achieve that desired price by buying and selling the legs at appropriate prices. For example, when a user instructs the trading tool to buy or sell the trading strategy 310 at a desired price, the automated trading tool may automatically place an order (also referred to as quoting an order) for one of the tradable objects 322 of the trading strategy 310 to achieve the desired price for the trading strategy (also referred to as a desired strategy price, desired spread price, and/or a target price). The leg for which the order is placed is referred to as the quoting leg. The other leg is referred to as a lean leg and/or a hedge leg. The price that the quoting leg is quoted at is based on a target price that an order could be filled at in the lean leg. The target price in the hedge leg is also known as the leaned on price, lean price, or lean level. Typically, if there is sufficient quantity available, the target price may be the best bid price when selling and the best ask price when buying. The target price may be different than the best price available if there is not enough quantity available at that price or because it is an implied price, for example. As the leaned on price changes, the price for the order in the quoting leg may also change to maintain the desired strategy price.

The leaned on price may also be determined based on a lean multiplier and/or a lean base. A lean multiplier may specify a multiple of the order quantity for the hedge leg that should be available to lean on that price level. For example, if a quantity of 10 is needed in the hedge leg and the lean multiplier is 2, then the lean level may be determined to be the best price that has at least a quantity of 20 available. A lean base may specify an additional quantity above the needed quantity for the hedge leg that should be available to lean on that price level. For example, if a quantity of 10 is needed in the hedge leg and the lean base is 5, then the lean level may be determined to be the best price that has at least a quantity of 15 available. The lean multiplier and lean base may also be used in combination. For example, the lean base and lean multiplier may be utilized such that larger of the two is used or they may be used additively to determine the amount of quantity to be available.

When the quoting leg is filled, the automated trading tool may then submit an order in the hedge leg to complete the strategy. This order may be referred to as an offsetting or hedging order. The offsetting order may be placed at the leaned on price or based on the fill price for the quoting order, for example. If the offsetting order is not filled (or filled sufficiently to achieve the desired strategy price), then the strategy order is said to be “legged up” or “legged” because the desired strategy relationship has not been achieved according to the trading strategy definition.

In addition to having a single quoting leg, as discussed above, a trading strategy may be quoted in multiple (or even all) legs. In such situations, each quoted leg still leans on the other legs. When one of the quoted legs is filled, the orders in the other quoted legs are typically cancelled and then appropriate hedge orders are placed based on the leaned on prices that the filled leg was based on.

### V. Dynamic Leaning Tools

As used herein, dynamic leaning refers to the concept of reducing the quantity in a quoting leg when the available leaned on quantity decreases (rather than re-quoting at a new price based on a new lean level with sufficient quantity available to meet the desired strategy quantity or pulling the quoting order out of the market because of insufficient quantity) and the corresponding behavior of how subsequent increases in available lean quantity are handled. Some dynamic leaning tools are discussed in U.S. Pat. No. 7,729,978, the contents of which are fully incorporated herein by reference.

The decrease in the quoting quantity may be viewed as taking the quantity out of the market. This removed quantity may be referred to as suspended quantity, for example. The quantity remaining in the market may be referred to as exempt quantity, which is exempt from being suspended.

When the quantity for a quoting order for a first tradable object is decreased according a dynamic leaning tool and that quoting order is filled, the desired quantity of the first tradable object to achieve the desired strategy quantity may not been achieved. A second quoting order (a reload quoting order) may be placed for some or all of the remaining quantity. The reload quoting order may be worked in a similar manner to the initial quoting order, for example.

In certain embodiments, placement of the reload quoting order is delayed. For example, the reload quoting order may be delayed by a predetermined amount of time such as 0.1, 0.5, 1.0, or 2.0 seconds, a random amount of time, or a variable amount of time. The delay in placing the reload quoting order may allow the market for a second tradable object to stabilize in response to a hedge order being placed in that market (where the hedge order was placed in response to the quoting order being filled).

In certain embodiments, re-quoting a quoting order at a new price is delayed. In particular, the quoting order may not be re-quoted at the new price until a delay time period has elapsed since the quoting order was last re-quoted. The delay time period may be, for example, between 1 and 50 milliseconds, such as 5 ms, 7 ms, 12 ms, or 20 ms. By doing this, re-quoting may be reduced if there is a “blip” in quantity available to lean on (resulting in a lean price change) that goes away quickly (resulting in another lean price change). In certain embodiments, the re-quoting of the quoting order is delayed only if the new price is into the market; if the new price is away from the market then the quoting order is re-quoted without a delay (as is typically done).

As used herein, the term lean quantity refers to the sufficient quantity available that a particular quoting order is leaning on (or is needed to lean on). The sufficient quantity available includes the quantity needed to offset the quoting order if it is filled (the lean order quantity) and, potentially, additional needed quantity, such as from a lean multiplier and/or lean base, for example. The actual quantity available in the market may be greater than the lean quantity.

For example, assume a desired strategy quantity of 10 is specified and that the trading strategy is defined with a spread ratio of 1:2, a lean multiplier of 1.25, a lean base of 5, and that the lean multiplier and lean base are additive. To place a quoting order in the first leg for a quantity of 10, an offset order quantity of (10 (desired strategy quantity)*2 (spread ratio))=20 is needed to complete the strategy. The sufficient quantity available needed in the second leg to lean on is then: (20 (offset order quantity)*1.25 (lean multiplier))+5 (lean base)=30. Thus, the lean quantity for the quoting order is 30. There may be more quantity available at the particular lean price level(s), but in order to place the quoting order with the full quantity of 10, the lean quantity needed is still 30 in this example. Also, if there is not enough quantity available in the market to lean on, even with dynamic leaning, the quoting order may be pulled out of the market.

In dynamic leaning, the decrease in the available lean quantity may be viewed as causing a decrease in the quoting quantity or a decrease in the desired strategy quantity (with a corresponding decrease in the quoting quantity as a consequence of the decrease in the desired strategy quantity). Practically, both approaches have similar effects in most cases, but with respect to implementation details, they may involve tracking additional variables and/or users may expect different results. For example, in the case where the desired strategy quantity is reduced, a user may expect that when the desired strategy quantity is specified and dynamic leaning is being used, the strategy order may be filled for a lesser quantity than desired or that an automated trading tool may have to track both the original desired strategy quantity as well as the reduced strategy quantity to implement the dynamic leaning behavior. For clarity, unless otherwise indicated, the present discussion of dynamic leaning will be described in terms of the former, decreasing quoting quantity, rather than decreasing the desired strategy quantity, but it should be understood that the dynamic leaning tools discussed herein may be applied under either approach.

The dynamic leaning tools implemented by the discussed embodiments herein may be viewed as tools to reduce re-quoting. Reducing re-quoting may be desirable because an exchange (or other entity) may place restrictions or disincentives, such as fees, on the number of quotes (or changes to quotes) that may be placed. For example, an exchange may require a user to receive at least one fill for every 20 quoting orders placed (or changes made those orders) or be subject to having orders rejected or assessed a fee. Re-quoting may be reduced by these tools because quoting orders may not be re-quoted at different price levels as frequently due to decreases in lean quantity. Instead, the quoting order quantity is reduced and its price is maintained. In addition, re-quoting may be reduced by these tools because the quoting orders are not changed when the quantity available to lean on increases. Further, reducing re-quoting may be desirable because fewer messages may be sent, thus reducing bandwidth usage.

The dynamic leaning tools implemented by the discussed embodiments herein may also be viewed as tools to preserve queue position, and thus potentially increase the chance of being filled, at the expense of not getting the full desired quantity. For example, by reducing the quoting order quantity when the available lean quantity changes rather than re-quoting at a different price level, queue position may be maintained, at the expense of getting less than the originally desired quantity for the order. The queue position may be maintained because, typically, when the quantity of an order is increased, the order is moved to the back of the queue. However, typically, when the quantity of an order is decreased, the order does not lose its position in the queue. The quoting order is more likely to be filled if it is near the front of the queue than at the back of the queue. It may be preferable to have some of the desired strategy quantity filled rather than have a lesser chance of having all of the desired strategy quantity filled at the risk of having none of it filled.

A. Increase on Re-Quote Tool

Certain embodiments provide an “increase on re-quote” tool. According to the techniques of this tool, when the quantity available in a lean leg increases after the quantity of a quoting order has previously been decreased (because of a decrease in lean quantity), the quantity for the quoting order is not increased until the quoting order is to be re-quoted at another price level.

For example, consider a trading strategy that is a spread between tradable object A and tradable object B, with a spread ratio of 1:−1. That is, when buying a quantity of 1 of the trading strategy, a quantity of 1 of A is bought and a quantity of 1 of B is sold and, similarly, a quantity of 1 of A is sold and a quantity of 1 of B is bought when selling the trading strategy. Now, assume a desired strategy quantity of 10 is specified. An automated trading tool may enter a quoting order to buy a quantity of 10 of A, leaning on the best bid price of B (assuming, for this example, there is sufficient quantity available at the best bid price of B). For this example, assume there is a quantity of 10 at the best bid price of B and that no additional quantity parameters have been specified. Thus, the lean quantity for the quoting order is 10 and there is sufficient quantity to lean on the best bid price of B for this trading strategy order.

Continuing the example, assume that the quantity available at the best bid price of B decreases to 8. Typical trading tools may determine a new lean price (perhaps the best price level at which sufficient quantity is available or a weighted average of quantity across multiple price levels) and re-quote the quoting order in A based on the new lean price. With dynamic leaning, however, the quantity of the quoting order may be reduced to 8 rather than re-quoting at a new price. The desired strategy quantity is still 10, but if the reduced-quantity quoting order is filled (as well as the corresponding hedge order), only a quantity of 8 of the strategy order will have been filled.

However, continuing the example, assume that the quoting order has not yet been filled and that the quantity available on the best bid price of B (which the quoting order is still leaning on) increases from 8 to 12. Now there is sufficient quantity available for the original desired strategy quantity. However, according to the techniques of the increase on re-quote tool, the quantity of the quoting order would not be increased. Instead, the quoting order quantity would refrain from being increased until the quoting order is to be re-quoted. The quoting order might be re-quoted because, for example, the market in B goes up and, thus, the best bid price of B goes up a price level. Because there is now quantity available at a “better” price to lean on, the lean price can be re-calculated and may result in a change in quoting price to maintain the desired strategy price. If the quoting order is re-quoted at a new price, then the re-quoted quoting order would be made for an increased quantity, up to the full quantity needed for the desired strategy quantity. Note that the re-quoted quoting order may not necessarily be for the full initially specified quantity, depending on how much new quantity is available at the new lean price and/or how much of the quoting order/desired strategy quantity has been filled.

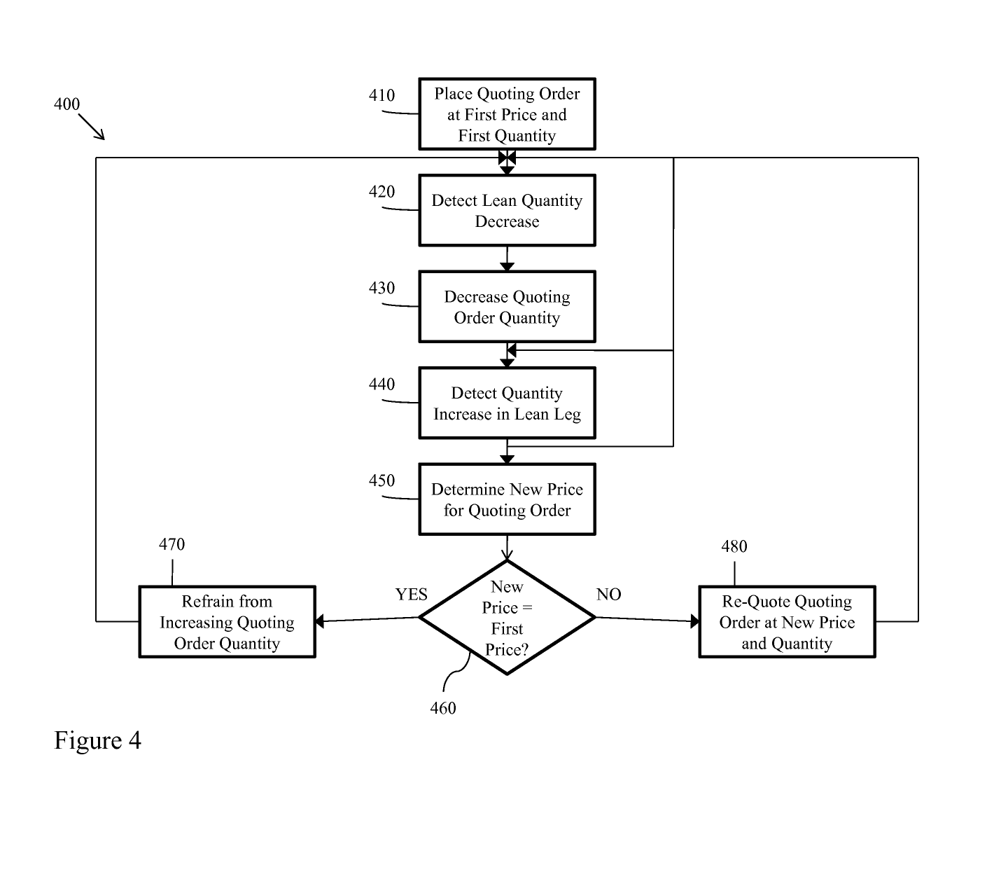

FIG. 4 illustrates an example flow diagram 400 of a method for dynamic leaning according to an embodiment of the increase on re-quote tool.

The following example is discussed below with respect to the flow diagram 400: consider a user wants to buy a trading strategy with a desired strategy price of 7 and a desired strategy quantity of 5. The trading strategy is a spread between tradable object TO1 and tradable object TO2. The spread ratio for the trading strategy is 1:−1. When buying 1 unit of the trading strategy, 1 unit of quantity of TO1 is bought and 1 unit of quantity of TO2 is sold. The quoting leg is TO1 and the lean leg is TO2. The best bid price for TO2 is 100 and a quantity of 12 is available at that price.

At block 410, a quoting order is placed at a first price and a first quantity. The quoting order is for a first tradable object. The first price leans on a lean quantity at a lean price in a second tradable object.

The quoting order may be placed by sending a message to an exchange to enter an order at the first price and for the first quantity for the first tradable object, for example.

With reference to the above example, because the quoting leg is TO1, the quoting order is leaning on the quantity available in the lean leg (TO2). The desired strategy quantity of 10 means that, based on the spread ratio, the desired quantity for the quoting leg is 10 and the desired quantity for the lean leg is 10, thus the lean quantity is 10. Since a quantity of 12 is available at the best bid price in TO2, there is sufficient quantity at the best bid price for a quoting order quantity of 10 to lean on (however, it should be understood that according to the techniques of the increase on re-quote tool the lean quantity could be spread across more than one price level). The quoting order is placed for a quantity of 10 at a price of: 7 (desired strategy price)+100 (lean price)=107.

At block 420, a decrease in lean quantity is detected. As discussed above, the lean quantity is the sufficient quantity available for the quoting order of block 410 to lean on. Thus, a decrease in the quantity available at the lean price may not necessarily be a decrease in the lean quantity if there was more quantity available at the lean price than the lean quantity.

The decrease in lean quantity may be detected by comparing the lean quantity to the quantity available at the lean price when a market update is received, for example.

With reference to the above example, assume the quantity available at the best bid price for TO2 decreases to 7. Because the lean quantity was 10 but there is now only a quantity of 7 available at the lean price level (the best bid price of TO2, 100), the drop in the available quantity in TO2 results in a decrease in the lean quantity to 7.

At block 430, the quantity for the quoting order is decreased. A new quantity for the quoting order may be determined for the quoting order based on the decreased lean quantity.

The quantity for the quoting order may be decreased by sending a message to an exchange to change the quantity for the quoting order to a lower quantity, for example.

With reference to the above example, the quantity for the quoting order is decreased to 7, based on the new lean quantity.

At block 440, an increase in the quantity available in a lean leg is detected. As discussed above, the lean quantity is the sufficient quantity available for the quoting order of block 410 to lean on. Since the quoting order quantity decreased at block 430, the lean quantity also decreased. However, an increase in the quantity available in the lean leg does not mean that the lean quantity has increased. Recall that the lean quantity is based on the quoting order quantity. The quoting order quantity is not increased just because the quantity available in the lean leg has increased. Rather, the increased quantity available to lean on is just that: increased quantity that could be leaned on if the quoting order quantity was increased. However, increasing the quoting order quantity may result in the quoting order losing queue position, which may be undesirable.

The increase in quantity available in the lean leg may be detected by comparing the decreased lean quantity to the quantity available at the lean price when a market update is received, for example.

With reference to the above example, assume the quantity available at the best bid price for TO2 increases to 15. As discussed above, this does not change the lean quantity for the quoting order, since the quantity of the quoting order is unchanged (and still 7) and it has a lean quantity of 7.

It should be understood that while the quoting order is pending at a particular price, a decrease in lean quantity (block 420) and a corresponding decrease in quoting order quantity (block 430) and an increase in the quantity available in a lean leg (block 440) may occur more than once. Additionally, the increase in the quantity available in a lean leg (block 440) could occur before and/or after a decrease in lean quantity (block 420).

At block 450, a new price for the quoting order is determined. The new price is determined based on the quantity available to lean on. If the quantity available to lean on has changed, it is possible the lean price has changed. For example, if the lean quantity spans more than one price level and the lean price is determined based on, for example, a weighted average of the lean quantity, then a change in the quantity available could result in a change in the lean price. As determined in block 460, discussed below, the new price for the quoting order could be the same as the current price for the quoting order.

With reference to the above example, because the lean quantity for the quoting order is all at the best bid price for TO2, the new price is: 7 (desired strategy price)+100 (lean price)=107.

At block 460, the new price is compared to the first price. If the new price is the same as the current price (that is, the first price from block 410) of the quoting order, then the method proceeds to block 470. If the new price is not the same as the current price of the quoting order, then the method proceeds to block 480.

With reference to the above example, because the new price (107) is the same as the price the current price (107), the method would proceed to block 470. However, an alternative example is also discussed below with respect to block 480.

At block 470, the quoting order quantity is refrained from increasing. That is, the method 400 intentionally does not increase the quantity of the quoting order even though the available quantity to lean on has increased. By not increasing the quantity of the quoting order, the quoting order's position in the queue is maintained. In addition, by not placing another order at the same price level to lean on the increased available quantity, an additional order does not need to be managed and an additional order is not counted against the trader by the exchange for fee purposes.

After refraining from increasing the quoting order quantity, the quoting order continues to be worked.

With reference to the above example, because the new price is the same as the current price, the quantity of the quoting order is not increased at this point.

At block 480, the quoting order is re-quoted. The quoting order is re-quoted at the new price level with a new lean quantity based on the increased quantity available. Note that the new lean quantity may not be the full quantity needed for the full desired quantity for the quoting order.

The quoting order may be re-quoted by sending a message to the exchange to cancel the quoting order and sending another message to the exchange to place a new order at the new price and quantity, for example. As another example, a single message with a cancel/replace command may be used. As another example, a single message with a change command may be used.

With reference to the above example, assume that at block 450 that the best bid price for TO2 went down to 99, that the quantity available at that price is 9, and that no other quantity is available to be leaned on at another price level. Because the quantity available to lean on is only 9 and is all at the new best bid price, the lean quantity is 9 and the lean price is 99. The new price for the quoting order is: 7 (desired strategy price)+99 (lean price)=106. According to block 460, the new price (106) is not the same as the price (107) for the quoting order. Therefore, according to the techniques of the increase on re-quote tool, the quoting order will be re-quoted at a price of 106 with an increased quantity of 9.

After re-quoting the quoting order, the quoting order continues to be worked.

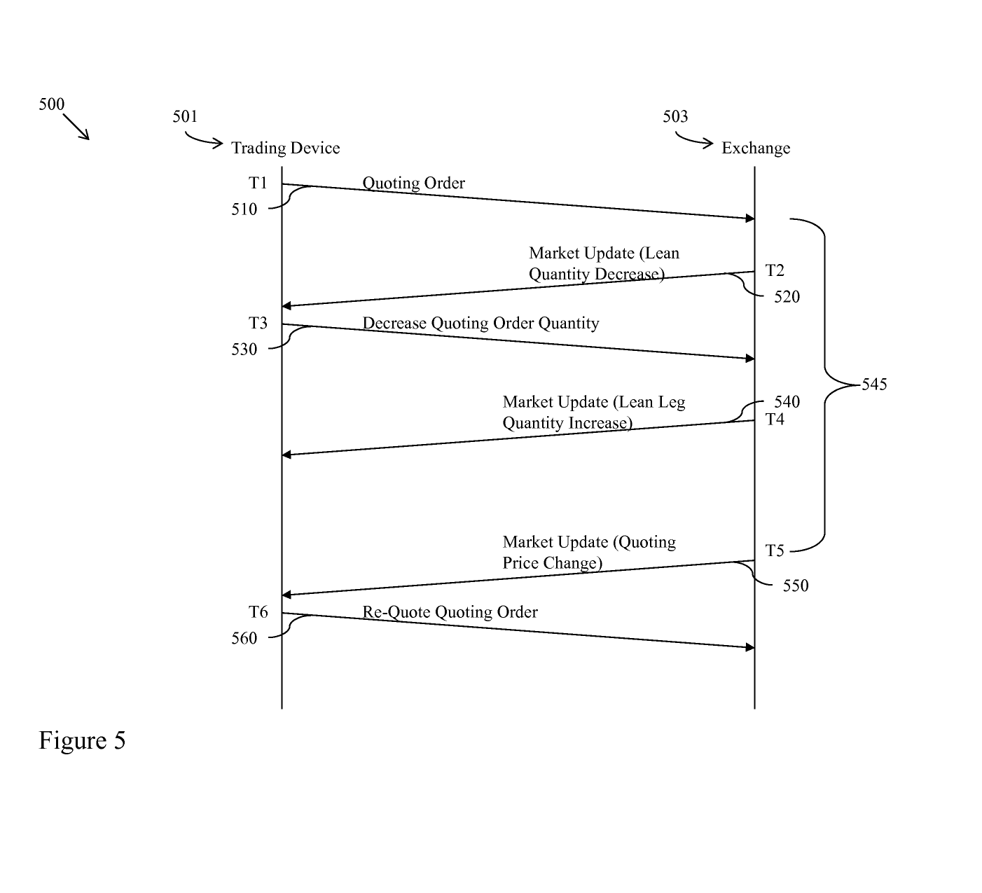

FIG. 5 illustrates a timing diagram 500 of an example sequence of messages according to an embodiment of the increase on request tool. The timing diagram 500 illustrates message between a trading device 501 and an exchange 503. The trading device 501 may be similar to the trading device 110 discussed above, for example. The exchange 503 may be similar to the exchange 130 discussed above, for example.

The illustrated messages in the timing diagram 500 may be communicated through intermediate devices such as a gateway similar to gateway 120 discussed above, for example. Additionally, while the illustrated messages in the timing diagram 500 are discussed with respect to a single exchange 503, in certain embodiments, the tradable object for the quoting leg and the tradable object for the lean leg may be at different exchanges.

At time T1, a quoting order message 510 is sent from the trading device 501 to the exchange 503. The quoting order message 510 enters a quoting order at the exchange 503. The quoting order is for a first tradable object at a first price that leans on a lean quantity at a lean price in a second tradable object.

At time T2, a market update message 520 is sent from the exchange 503 to the trading device 501. The market update message 520 includes updated quantity information for a lean leg of the quoting order reflecting a decrease in the lean quantity for the quoting order. Note that the market update message 520 may not expressly indicate a decrease in the lean quantity for the quoting order, but instead may include updated quantity information that may be processed (for example, by the trading device 501) to determine the decrease in the lean quantity. The decrease in the lean quantity for the quoting order may be detected by comparing the updated quantity information in the market update message 520 to the lean quantity for the quoting order before the market update message 520 was received, for example.

At time T3, a decrease quoting order quantity message 530 is sent from the trading device 501 to the exchange 503. The decrease quoting order quantity message 530 specifies that the quantity for the quoting order is to be decreased to a new quantity based on the decreased lean quantity.

At time T4, a market update message 540 is sent from the exchange 503 to the trading device 501. The market update message 540 includes updated quantity information for a lean leg of the quoting order reflecting an increase in the quantity available to lean on in the lean leg. Note that the market update message 540 may not expressly indicate an increase in the quantity available to lean on in the lean leg, but instead may include updated quantity information that may be processed (for example, by the trading device 501) to determine that the quantity available to lean on has increased. Recall that, as discussed above, an increase in the quantity available in a lean leg does not mean that lean quantity is increased. Rather, according to the techniques of the increase on re-quote tool, the trading device 501 refrains from increasing the quantity of the quoting order even though additional quantity is available to lean on.

It should be understood that while the quoting order is pending at a particular price (denoted by time period 545), market update messages similar to market update message 520 and/or market update message 540 may be received more than once. Additionally, market update messages similar to market update message 540 may be received before and/or after market update messages similar to market update message 520. Also, decrease quoting order quantity messages similar to decrease quoting order quantity message 530 may be sent more than once corresponding to the received market update messages similar to market update message 520.

At time T5, a market update message 550 is sent from the exchange 503 to the trading device 501. The market update message 550 includes updated market data for a lean leg of the quoting order reflecting a change in the quoting price for the quoting order. That is, based on the updated market data in the market update message 550, a new quoting price is determined for the quoting order.

At time T6, a re-quote quoting order message 560 is sent from the trading device 501 to the exchange 503. The re-quote quoting order message 560 enters a quoting order at the exchange 503 at the new quoting price and at a quantity based on the new lean quantity. The re-quote quoting order message 560 may be a single cancel/replace message or a single change message, for example. As another example, the re-quote quoting order message 560 may include a cancel message to cancel the quoting order and an order message to place the new quoting order at the new price.

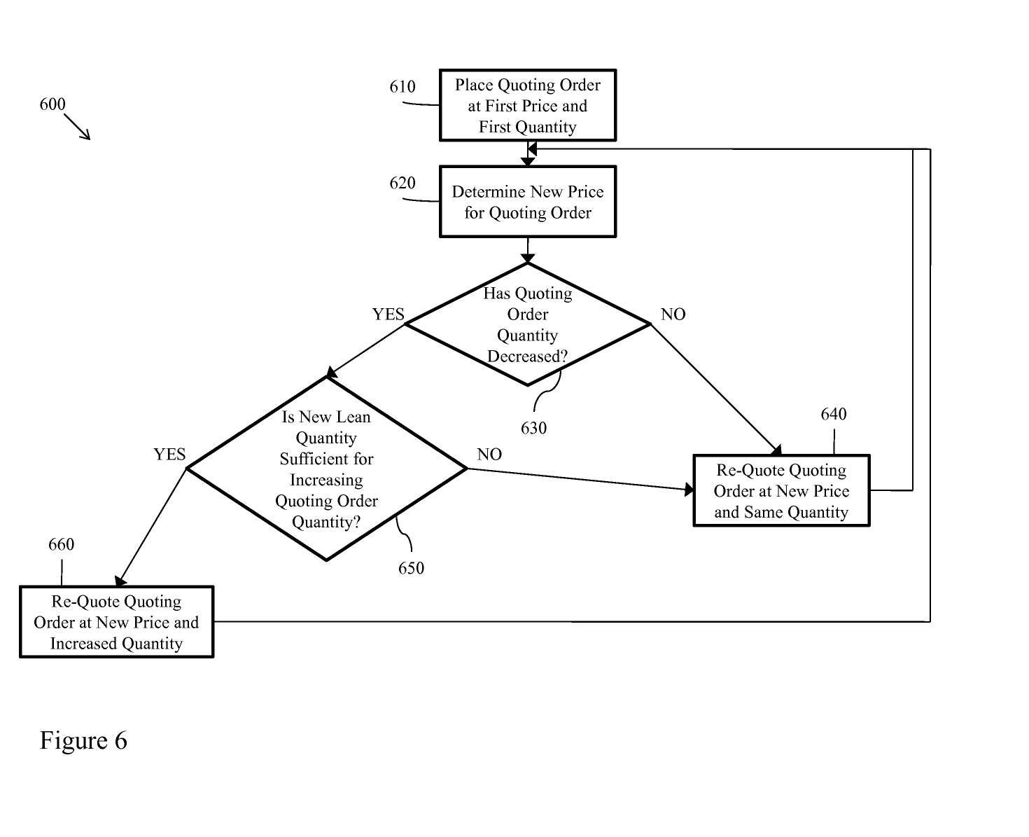

FIG. 6 illustrates an example flow diagram 600 of a method for dynamic leaning according to an embodiment of the increase on re-quote tool.

At block 610, a quoting order is placed. The quoting order is placed at a first price and a first quantity. The quoting order leans on a lean quantity. The first price, the first quantity, and the lean quantity may be determined based on a desired strategy quantity and desired strategy price specified by a user, for example.

While the quoting order is working and has not been completely filled, the lean quantity may decrease. If so, the quantity for the quoting order may decrease to a new quantity based on the new lean quantity. While working, the quantity of the quoting order may decrease more than once based on changing lean quantity. If the quantity available in the lean leg increases after the quoting order quantity has been decreased, the quoting order quantity is not increased to lean on the increased quantity while the quoting order is working at the same price.

At block 620, a new price for a quoting order is determined. The new price is different from the first price. The new price for the quoting order may be determined based on a change in the market in a lean leg, for example. When a new price is determined for the quoting order, the quoting order is to be re-quoted at the new price.

At block 630, if the quoting order quantity has not decreased, then the method proceeds to block 640. If the quoting order quantity has decreased, then the method proceeds to block 650. The quoting order quantity may have decreased from the first quantity based on changes in the lean quantity, as discussed above.

At block 640, the quoting order is re-quoted at the new price and the same quantity. The quoting order continues to work at the new price. A new price for the re-quoted quoting order may subsequently be determined as in block 620.

At block 650, if the new lean quantity is not sufficient for increasing the quoting order quantity, the method proceeds to block 640. If the new lean quantity is sufficient for increasing the quoting order quantity, the method proceeds to block 660. Although a new lean quantity may have been determined when the new price for the quoting order was determined, the new lean quantity may not be sufficient to increase the quantity of the quoting order when it is re-quoted.

At block 660, the quoting order is re-quoted at the new price and an increased quantity. The increased quantity for the re-quoted quoting order is with respect to the decreased quantity of the quoting order as determined at block 630. Because the new price that the quoting order is to be re-quoted at has sufficiently greater lean quantity, the re-quoted quoting order can be placed with increased quantity.

The increased quantity may be a quantity increased up to the first quantity, for example. In certain embodiments, if it has been indicated that more quantity than originally specified is acceptable, the increased quantity be greater than the first quantity. In these embodiments, it would be understood by a user that this behavior could occur and might be desirable/explained by the view that “I want 10, but if I can get more, that would be good too.” In this case, it is possible that the increase in the quoting order quantity could occur even if there was never a preceding decrease in quantity.

B. Quote Inside Market Only and Reload Tool

Certain embodiments provide a “quote inside market only and reload” tool. According to the techniques of this tool, a quoting order only leans on the inside market and, when the leaned on quantity decreases, the quoting quantity is reduced as appropriate. The quoting quantity does not increase, even if the available quantity in a lean leg increases. Instead, when the quoting order is filled, the strategy order is reloaded by placing a new quoting order for the remaining desired quantity, again leaning on only the quantity available at the inside market. This tool expressly does not lean into the market depth.

For example, consider a trading strategy that is a spread between tradable object A and tradable object B, with a spread ratio of 1:−1. That is, when buying a quantity of 1 of the trading strategy, a quantity of 1 of A is bought and a quantity of 1 of B is sold and, similarly, a quantity of 1 of A is sold and a quantity of 1 of B is bought when selling the trading strategy. Now, assume a desired strategy quantity of 10 is specified. An automated trading tool may enter a quoting order to buy a quantity of 10 of A, leaning on only the best bid price of B. For this example, assume there is a quantity of 10 at the best bid price of B and that no additional quantity parameters have been specified. Thus, the lean quantity for the quoting order is 10 and there is sufficient quantity to lean on the best bid price of B for this trading strategy order.

Continuing the example, assume that the quantity available at the best bid price of B decreases to 8. Typical trading tools may determine a new lean price (perhaps the best price level at which sufficient quantity is available or a weighted average of quantity across multiple price levels) and re-quote the quoting order in A based on the new lean price. With dynamic leaning, however, the quantity of the quoting order may be reduced to 8 rather than re-quoting at a new price. The desired strategy quantity is still 10, but if the reduced-quantity quoting order is filled (as well as the corresponding hedge order), only a quantity of 8 of the strategy order will have been filled.

However, continuing the example, assume that the quoting order has not yet been filled and that the quantity available on the best bid price of B (which the quoting order is still leaning on) increases from 8 to 12. Now there is sufficient quantity available for the original desired strategy quantity. However, according to the techniques of the quote inside market only and reload tool, the quantity of the quoting order would not be increased. Instead, the quoting order would continue to be worked, leaning on only the best bid price of B, until the quoting order is filled. While the quoting order is working, the lean quantity may decrease more than once which may result in the quoting order quantity decreasing more than once. In addition, while working, the quoting order may be re-quoted at different price levels based on changes in the lean price, for example. However, even when re-quoted, according to the techniques of the quote inside market only and reload tool, the quoting order quantity is not increased. This may be because the decreases in quoting order quantity may be viewed as indicating the market is not liquid enough (and/or additional available quantity may be viewed as being too transient) to support the larger quantity, so even though the lean price changes, the smaller quantity is the more appropriate size. By not increasing the quoting order quantity when the quoting order is re-quoted, additional messages to decrease the order quantity are not needed. Once the quoting order has been filled, a reload quoting order is placed for the remaining desired quantity.

Certain embodiments provide a variation on the quote inside market only and reload tool, which allows a quoting order to lean on quantity available away from the inside market—a “decrease only and reload” tool. Aside from the distinction of allowing a quoting order (include any subsequent reload orders) to lean on quantity available away from the inside market, the decrease only and reload tool behaves the same as the quote inside market only and reload tool and therefore will not be discussed separately.

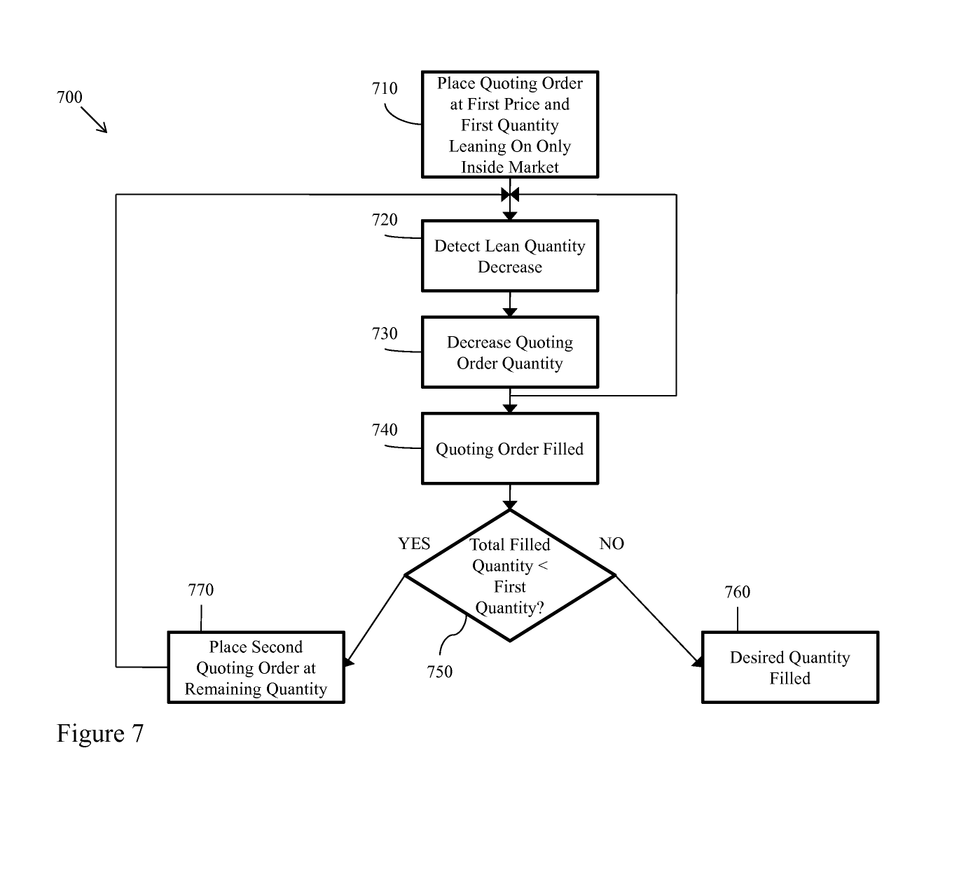

FIG. 7 illustrates an example flow diagram 700 of a method for dynamic leaning according to an embodiment of the quote inside market only and reload tool.

The following example is discussed below with respect to the flow diagram 700: consider a user wants to buy a trading strategy with a desired strategy price of 7 and a desired strategy quantity of 5. The trading strategy is a spread between tradable object TO1 and tradable object TO2. The spread ratio for the trading strategy is 1:−1. When buying 1 unit of the trading strategy, 1 unit of quantity of TO1 is bought and 1 unit of quantity of TO2 is sold. The quoting leg is TO1 and the lean leg is TO2. The best bid price for TO2 is 100 and a quantity of 12 is available at that price.

At block 710, a quoting order is placed at a first price and a first quantity. The quoting order is for a first tradable object. The first price leans on a lean quantity including only the quantity available at the inside market of a second tradable object. In certain embodiments, if the trading strategy has more than two legs, the first price leans on a lean quantity determined based on only the quantity available at the inside market of each of the other legs.

The quoting order may be placed by sending a message to an exchange to enter an order at the first price and for the first quantity for the first tradable object, for example.

With reference to the above example, because the quoting leg is TO1, the quoting order is leaning on the quantity available in the lean leg (TO2). The desired strategy quantity of 10 means that, based on the spread ratio, the desired quantity for the quoting leg is 10 and the desired quantity for the lean leg is 10, thus the lean quantity is 10. According to the techniques of the quote inside market only and reload tool, only quantity at the inside market may be available to lean on. Since a quantity of 12 is available at the best bid price in TO2, there is sufficient quantity at the best bid price for a quoting order quantity of 10 to lean on. The quoting order is placed for a quantity of 10 at a price of: 7 (desired strategy price)+100 (lean price)=107.

At block 720, a decrease in lean quantity is detected. As discussed above, the lean quantity is the sufficient quantity available for the quoting order of block 710 to lean on. Thus, a decrease in the quantity available at the lean price may not necessarily be a decrease in the lean quantity if there was more quantity available at the lean price than the lean quantity.

The decrease in lean quantity may be detected by comparing the lean quantity to the quantity available at the lean price when a market update is received, for example.

With reference to the above example, assume the quantity available at the best bid price for TO2 decreases to 7. Because the lean quantity was 10 but there is now only a quantity of 7 available at the lean price level (the best bid price of TO2, 100), the drop in the available quantity in TO2 results in a decrease in the lean quantity to 7.

At block 730, the quantity for the quoting order is decreased. A new quantity for the quoting order may be determined for the quoting order based on the decreased lean quantity.

The quantity for the quoting order may be decreased by sending a message to an exchange to change the quantity for the quoting order to a lower quantity, for example.

With reference to the above example, the quantity for the quoting order is decreased to 7, based on the new lean quantity.

It should be understood that while the quoting order is pending, a decrease in lean quantity (block 720) and a corresponding decrease in quoting order quantity (block 730) may occur more than once. Additionally, the quantity available to lean on at the inside market may increase, but according to the techniques of the quote inside market only and reload tool, the quoting order quantity will not be increased to lean on the increased available quantity. Also, the quoting order may be re-quoted at a different price based on changes in the market in a lean leg.

At block 740, the quoting order is filled. The quantity of the quoting order is completely filled, not just partially filled. Note that, since the quoting order quantity was decreased at block 730, the desired quantity of the first tradable object to achieve the desired strategy quantity may not have been achieved. In certain embodiments, a hedge order is sent when the quoting order is filled.

The quoting order being filled may be detected by receiving a message from an exchange indicating the filled quantity for the quoting order, for example.

With reference to the above example, a fill confirmation is received indicating that the quoting order's quantity of 7 was filled.

At block 750, the filled quantity is compared to the first quantity. If the filled quantity is not less than the first quantity, then the method proceeds to block 760. If the filled quantity is less than the first quantity, then the method proceeds to block 770. This comparison assumes that the first quantity is equal to the desired quantity of the first tradable object to achieve the desired strategy quantity. In certain embodiments, the first quantity may be less than the desired quantity of the first tradable object to achieve the desired strategy quantity. For example, if the strategy order is an iceberg order or a reload order.

With reference to the above example, because the filled quantity (7) is less than the first quantity of the quoting order (10), the method would proceed to block 770. However, if the initial desired quantity for the quoting order has been filled (block 760), no additional quoting orders need to be worked.

At block 760, the desired quantity has been filled. Therefore, the desired quantity of the first tradable object to achieve the desired strategy quantity has been filled.

At block 770, a second quoting order is placed for the remaining quantity. Because the desired quantity of the first tradable object to achieve the desired strategy quantity has not been filled, a second quoting order, a reload quoting order, is placed for the remaining quantity. The reload quoting order may be worked in a similar manner to the initial quoting order, for example.

In certain embodiments, the reload quoting order may be for only a portion of the remaining quantity, with one or more additional reload quoting orders being placed, as each prior reload quoting order is filled, for portions of the initially desired quantity of the quoting order.

The second quoting order may be placed by sending a message to an exchange to enter an order for the remaining quantity for the first tradable object, for example.

With reference to the above example, only a quantity of 7 was filled and the desired quantity for the initial quoting order was 10. Therefore, a quantity of 3 remains to be filled in the quoting leg. The second quoting order would be placed with an initial quantity of 3 (or up to 3, depending on the quantity available to lean on when the second quoting order is placed).

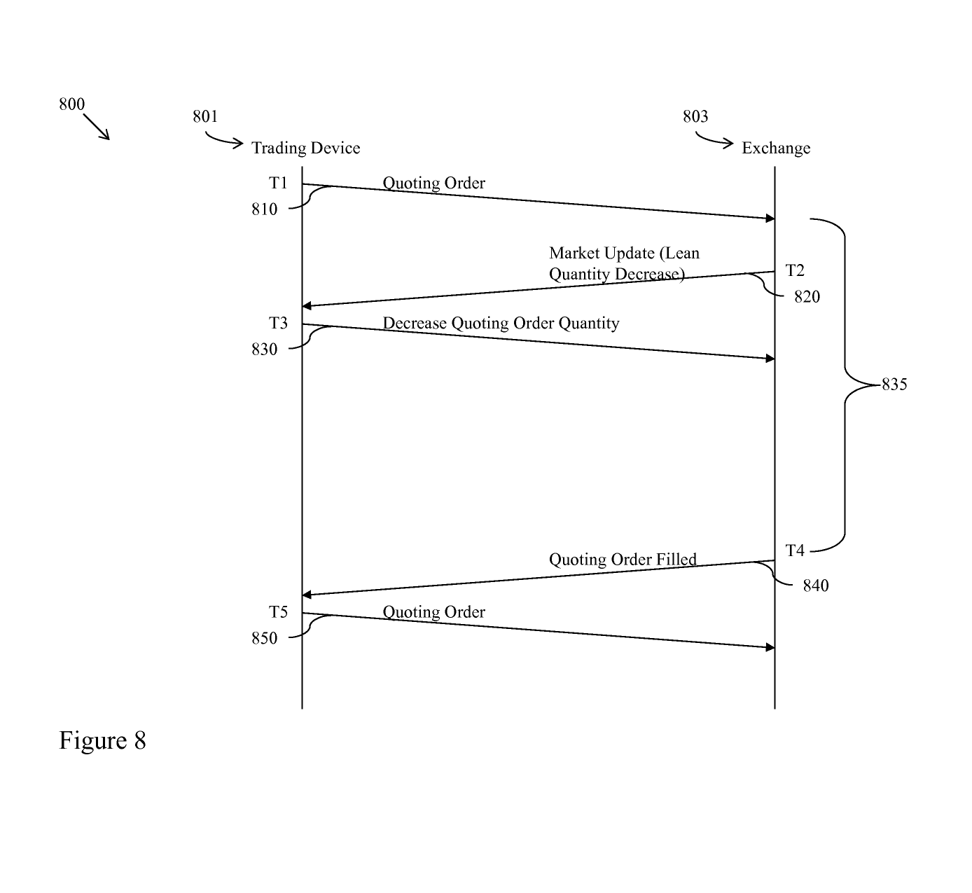

FIG. 8 illustrates a timing diagram 800 of an example sequence of messages according to an embodiment of the quote inside market only and reload tool. The timing diagram 800 illustrates message between a trading device 801 and an exchange 803. The trading device 801 may be similar to the trading device 110 discussed above, for example. The exchange 803 may be similar to the exchange 130 discussed above, for example.

The illustrated messages in the timing diagram 800 may be communicated through intermediate devices such as a gateway similar to gateway 120 discussed above, for example. Additionally, while the illustrated messages in the timing diagram 800 are discussed with respect to a single exchange 803, in certain embodiments, the tradable object for the quoting leg and the tradable object for the lean leg may be at different exchanges.

At time T1, a quoting order message 810 is sent from the trading device 801 to the exchange 803. The quoting order message 810 enters a quoting order at the exchange 803. The quoting order is for a first tradable object at a first price that leans on a lean quantity including only the quantity available at the inside market of a second tradable object. In certain embodiments, if the trading strategy has more than two legs, the first price leans on a lean quantity determined based on only the quantity available at the inside market of each of the other legs.

At time T2, a market update message 820 is sent from the exchange 803 to the trading device 801. The market update message 820 includes updated quantity information for a lean leg of the quoting order reflecting a decrease in the lean quantity for the quoting order. Note that the market update message 820 may not expressly indicate a decrease in the lean quantity for the quoting order, but instead may include updated quantity information that may be processed (for example, by the trading device 801) to determine the decrease in the lean quantity. The decrease in the quantity for the quoting order may be detected by comparing the updated quantity information in the market update message 820 to the lean quantity for the quoting order before the market update message 820 was received, for example.

At time T3, a decrease quoting order quantity message 830 is sent from the trading device 801 to the exchange 803. The decrease quoting order quantity message 830 specifies that the quantity for the quoting order is to be decreased to a new quantity based on the decreased lean quantity.

It should be understood that while the quoting order is pending at a particular price (denoted by time period 835), market update messages similar to market update message 820 may be received (and a corresponding decrease quoting order quantity message similar to the decrease quoting order quantity message 830 may be sent) more than once. Additionally, market update messages reflecting an increase in the quantity available to lean on in the lean leg and/or reflecting a new quoting order price may be received before and/or after market update messages similar to market update message 820. Recall that, as discussed above, an increase in the quantity available in a lean leg does not mean that lean quantity is increased. Rather, according to the techniques of the quote inside market only and reload tool, lean quantity is not increased.

At time T4, a fill message 840 is sent from the exchange 803 to the trading device 801. The fill message 840 indicates that the quantity of the quoting order has been filled. Because the quoting order quantity was decreased by the decrease quoting order quantity message 830, the desired quantity of the first tradable object to achieve the desired strategy quantity has not been achieved.

At time T5, a second quoting order message 850 is sent from the trading device 801 to the exchange 803. The second quoting order message 850 enters a second quoting order, a reload quoting order. The reload quoting order is placed for the remaining quantity (or a portion of the remaining quantity). The reload quoting order may be worked in a similar manner to the initial quoting order, for example.

C. Example Trading Device

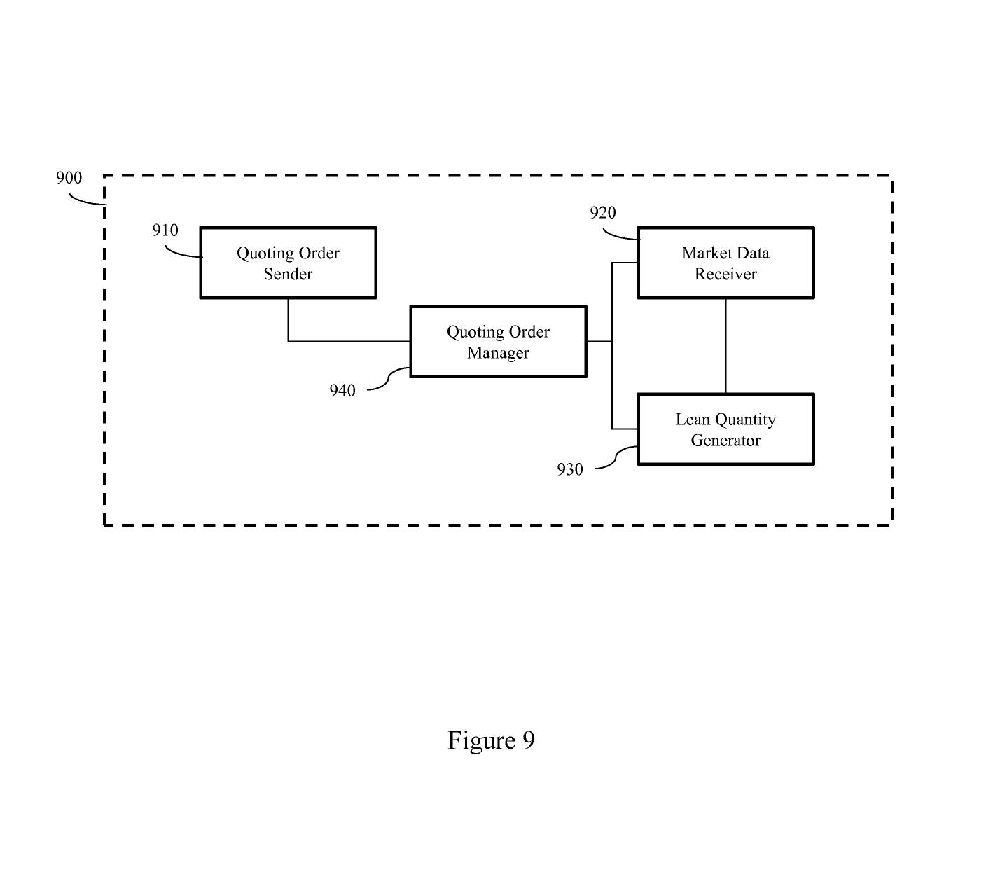

FIG. 9 illustrates a block diagram of an example trading device 900 in accordance with certain embodiments. The trading device 900 may be similar to the trading device 110 discussed above, for example. The trading device 900 includes a quoting order sender 910, a market data receiver 920, a lean quantity generator 930, and a quoting order manager 940.

The quoting order sender 910 sends messages to place and change a quoting order. The messages may be sent to an exchange similar to exchange 130 discussed above, for example.

The market data receiver 920 receives market data. The market data may be received from an exchange similar to exchange 130 discussed above, for example.

The lean quantity generator 930 determines a lean quantity. The lean quantity may be determined based on a definition for a trading strategy, a desired strategy quantity, and market data received by the market data receiver 920, for example.

The quoting order manager 940 manages a quoting order sent by the quoting order sender 910. In certain embodiments, the quoting order manager 940 manages the quoting order according to the techniques of the increase on re-quote tool discussed above. In certain embodiments, the quoting order manager 940 manages the quoting order according to the techniques of the quote inside market only and reload tool discussed above.

Some of the described figures depict example block diagrams, systems, and/or flow diagrams representative of methods that may be used to implement all or part of certain embodiments. One or more of the components, elements, blocks, and/or functionality of the example block diagrams, systems, and/or flow diagrams may be implemented alone or in combination in hardware, firmware, discrete logic, as a set of computer readable instructions stored on a tangible computer readable medium, and/or any combinations thereof, for example.

The example block diagrams, systems, and/or flow diagrams may be implemented using any combination of application specific integrated circuit(s) (ASIC(s)), programmable logic device(s) (PLD(s)), field programmable logic device(s) (FPLD(s)), discrete logic, hardware, and/or firmware, for example. Also, some or all of the example methods may be implemented manually or in combination with the foregoing techniques, for example.

The example block diagrams, systems, and/or flow diagrams may be performed using one or more processors, controllers, and/or other processing devices, for example. For example, the examples may be implemented using coded instructions, for example, computer readable instructions, stored on a tangible computer readable medium. A tangible computer readable medium may include various types of volatile and non-volatile storage media, including, for example, random access memory (RAM), read-only memory (ROM), programmable read-only memory (PROM), electrically programmable read-only memory (EPROM), electrically erasable read-only memory (EEPROM), flash memory, a hard disk drive, optical media, magnetic tape, a file server, any other tangible data storage device, or any combination thereof. The tangible computer readable medium is non-transitory.

Further, although the example block diagrams, systems, and/or flow diagrams are described above with reference to the figures, other implementations may be employed. For example, the order of execution of the components, elements, blocks, and/or functionality may be changed and/or some of the components, elements, blocks, and/or functionality described may be changed, eliminated, sub-divided, or combined. Additionally, any or all of the components, elements, blocks, and/or functionality may be performed sequentially and/or in parallel by, for example, separate processing threads, processors, devices, discrete logic, and/or circuits.

While embodiments have been disclosed, various changes may be made and equivalents may be substituted. In addition, many modifications may be made to adapt a particular situation or material. Therefore, it is intended that the disclosed technology not be limited to the particular embodiments disclosed, but will include all embodiments falling within the scope of the appended claims.

1. A method including:
receiving by a computing device a definition for a trading strategy including a first tradable object and a second tradable object;
receiving by the computing device a desired strategy price and a desired strategy quantity for a trading strategy order;
sending by the computing device a command to place a quoting order for the first tradable object having an order quantity, wherein the quoting order leans on a lean quantity in the second tradable object, wherein the lean quantity is based on the definition for the trading strategy, the desired strategy quantity, and market data for the second tradable object;
detecting by the computing device a decrease in the lean quantity for the quoting order;
sending by the computing device a command to decrease the order quantity of the quoting order based on the detected decrease in the lean quantity;
detecting by the computing device an increase in quantity available to lean on in the second tradable object;
determining by the computing device a first new price for the quoting order based on the desired strategy price, the decreased order quantity, and market data for the second tradable object, wherein the first new price is the same as the order price;
refraining by the computing device from sending a command to increase the order quantity of the quoting order when the first new price is the same as the order price;
detecting by the computing device a change in quantity available to lean on in the second tradable object;
determining by the computing device a second new price for the quoting order based on the definition for the trading strategy, the desired strategy price, the decreased order quantity, and market data for the second tradable object, wherein the second new price is different than the order price; and
re-quoting by the computing device the quoting order at the second new price and at a new quantity when the second new price is different than the order price, wherein the new quantity is greater than the decreased order quantity.

2. The method of claim 1, wherein the lean quantity includes quantity available at a plurality of price levels for the second tradable object.

3. The method of claim 1, wherein the definition for the trading strategy includes a parameter specifying additional quantity to be available to lean on.

4. The method of claim 3, wherein the parameter includes at least one of a lean multiplier and a lean base.

5. The method of claim 1, wherein detecting the decrease in the lean quantity for the quoting order includes comparing quantity information in market data for the second tradable object with the lean quantity.

6. The method of claim 1, wherein re-quoting the quoting order includes:
sending by the computing device a command to cancel the quoting order; and
sending by the computing device a command to place a second quoting order for the first tradable object at the second new price and at the new quantity.

7. The method of claim 1, wherein re-quoting the quoting order includes:
sending by the computing device a command to cancel/replace the quoting order at the second new price and at the new quantity.

8. A method including:
sending by a computing device a command to place a quoting order for a first tradable object at a first price and a first quantity, wherein the quoting order leans on a lean quantity in a second tradable object;
sending by the computing device a command to decrease the order quantity of the quoting order based on a decrease in the lean quantity;
determining by the computing device a new price for the quoting order, wherein the new price is based on a definition for a trading strategy, a desired strategy price, the decreased order quantity, and market data for the second tradable object, wherein the trading strategy includes the first tradable object and the second tradable object, wherein the new price is different from the first price; and
re-quoting by the computing device the quoting order at the new price and a new quantity when the new price is different than the first price, wherein the new quantity is greater than the decreased order quantity.

9. The method of claim 8, wherein the lean quantity includes quantity available at a plurality of price levels for the second tradable object.

10. The method of claim 8, wherein the definition for the trading strategy includes a parameter specifying additional quantity to be available to lean on.

11. The method of claim 10, wherein the parameter includes at least one of a lean multiplier and a lean base.

12. The method of claim 8, wherein re-quoting the quoting order includes:
sending by the computing device a command to cancel the quoting order; and
sending by the computing device a command to place a second quoting order for the first tradable object at the new price and at the new quantity.

13. The method of claim 8, wherein re-quoting the quoting order includes:
sending by the computing device a command to cancel/replace the quoting order at the new price and at the new quantity.

14-18. (canceled)
